(19) United States
(12) Patent Application Publication
(10) Pub. No.: US 2006/0122859 A1
(43) Pub. Date: Jun. 8, 2006

(54) Communities of practice environment

(75) Inventors: Jerome A. Feldman, Emeryville, CA (US); David B. Thaw, Novato, CA (US)

Correspondence Address: FISH & RICHARDSON P.C., PO BOX 1022, MINNEAPOLIS, MN, 55440-1022, US

(73) Assignee: International Computer Science Institute, Berkeley, CA (US)

(21) Appl. No.: 11/292,929

(22) Filed: Dec. 1, 2005

Related U.S. Application Data
(60) Provisional application No. 60/633,363, filed on Dec. 4, 2004.

(51) Int. Cl. G06Q 99/00

(52) U.S. Cl. 705/1

(57) ABSTRACT

Methods and apparatus, including systems and computer program products, for implementing environments that provide user groups with the ability to post, discuss, and manage group content, and the ability to organize and make group decisions, based on the content of documents. One method includes managing documents according to a respective document state for each document in the environment. The possible document states include a submitted state, a voting state, an approved state, and a not approved state. A group member submitting a document to the group places the document in the submitted state. When the group coordinator enables voting on the document, it moves to the voting state. If the members approve the document, it moves from the voting to the approved state; and otherwise, the document moves from the voting to the not approved state.

### CROSS-REFERENCE TO RELATED APPLICATIONS

This application claims priority under 35 U.S.C. § 119(e) to U.S. patent application Ser. No. 60/633,363, entitled “CoPE: the community of practice environment”, which was filed on Dec. 4, 2004. The disclosure of the above application is incorporated herein by reference in its entirety.

### BACKGROUND AND SUMMARY

The present invention relates to computer supported cooperative work and decision making.

This specification describes implementations of a system in accordance with the invention that in operation implements one or more communities of practice environments (which will be referred to as “CoPEs”, or simply “environments”). A CoPE can be implemented as a web-based environment for collaboration and governance for groups, such as community organizations, that lack technical information technology expertise. It is now well known that the availability of computer supported cooperative work (CSCW) technology can have a profound effect on the ability of organizations to operate, particularly if they are physically dispersed. Current content management systems generally fail to balance capability with ease-of-use. Systems requiring little technical expertise or expense generally provided limited functionality and cannot be customized to varying groups' needs. Conversely, systems that provided a high level of flexibility and customization have required extensive technical expertise and have been cost-prohibitive for the many groups.

A system in accordance with the invention can implement environments that provide user groups with two primary functionalities: 1) the ability to post, discuss, edit, and manage individual and group content and 2) the ability to organize and make group decisions, based on the content of documents. The system can also allow groups to adapt the system workflow to their organizational model by selecting values for simple parameters, such as the form of voting. An environment has a set of characteristics that can be customized by a manageably small set of parameters. By selecting values for these parameters, an individual organization can adapt an environment to its workflow.

The system can provide to a group a collaboration system that does not require the group to adapt its workflow to meet rigid system requirements. Furthermore, for groups that have not yet developed or are in the process of developing collaboration processes, the choices the system provides can aid them in developing those processes. The system supports a full range of governance capabilities to allow a group to establish and operate a democratic organization, cooperating through the use of shared documents and procedures.

Such a system can be implemented on a web site to bring these capabilities to anyone who can use a web site. Supported processes include proposing, exchanging comments on, and providing an approval system for documents; and discussing and taking action on items of business.

Such a system can implement a workflow for the democratic creation, discussion and approval of work products represented as documents; document management tools for organizing and searching documents; group management tools for determining group membership and document access and modification privileges; document management tools allowing for separating public and private documents; archival tools for sending documents to archival storage and later retrieving them; commenting tools providing a hierarchical, context-based commenting system for commenting on documents and on other comments; and an ability for a group to reconsider approved documents as circumstances change.

Such a system can exploit a synergy between governance support, i.e., voting and discussion machinery with kinds of voting, and automated CSCW. Computer supported democratic governance is based on shared information which is provided by document management; and the document approval process is the mechanism of group decision making. In the other direction, the flexible group governance mechanism supports the democratic production of any work products that can be expressed as documents. These work products could include laws of a legislative body, best practices of a professional group, student group projects, and so on.

The invention can be implemented to realize one or more of the following advantages.

A system can be implemented to give non-technical user groups the ability to manage and customize their work environment and document workflow. Support for pre-modeled workflows allows groups without pre-existing management structures develop them. A content management system can be implemented that supports organizing and operating democratic governance structures. A content management system can be implemented that is customizable but does not require ongoing technical support for customization. A system can be implemented that helps groups develop workflow and governance structures.

The details of one or more embodiments of the invention are set forth in the accompanying drawings and the description below. Other features and advantages of the invention will become apparent from the description, the drawings, and the claims.

### BRIEF DESCRIPTION OF THE DRAWINGS

FIG. 1 is a state transition diagram for a default workflow.

FIG. 2 is a table showing permissions relative to document states and member status.

FIG. 3 illustrates an example user interface workspace.

FIG. 4 illustrates an example of part of a coordinator interface workspace.

FIG. 5 illustrates a configuration interface.

Like reference numbers and designations in the various drawings indicate like elements.

### DETAILED DESCRIPTION

This specification describes implementations of a system in accordance with the invention that in operation implements one or more communities of practice environments (which will be referred to as “CoPEs”, or simply “environments”).

Such a system is configured to address the needs of certain types of organizations. Specifically, it incorporates into a single system the range of options and workflow flexibility required by varying types of groups, including community and other non-hierarchical organizations. It requires the group designate an individual or individuals to act as the communities of practice environment coordinator for each environment. The coordinator is responsible for organizing the activities of the group, including setting configuration options. In the implementation of the system that will be described, the system is so constructed that the coordinator does not need any advanced technical expertise to accomplish these tasks. A basic understanding of computer operation and web browsing is sufficient.

The system has four aspects: 1) the workflow design; 2) the user interface; 3) the group decision mechanisms, and 4) the configuration system.

Workflow Design

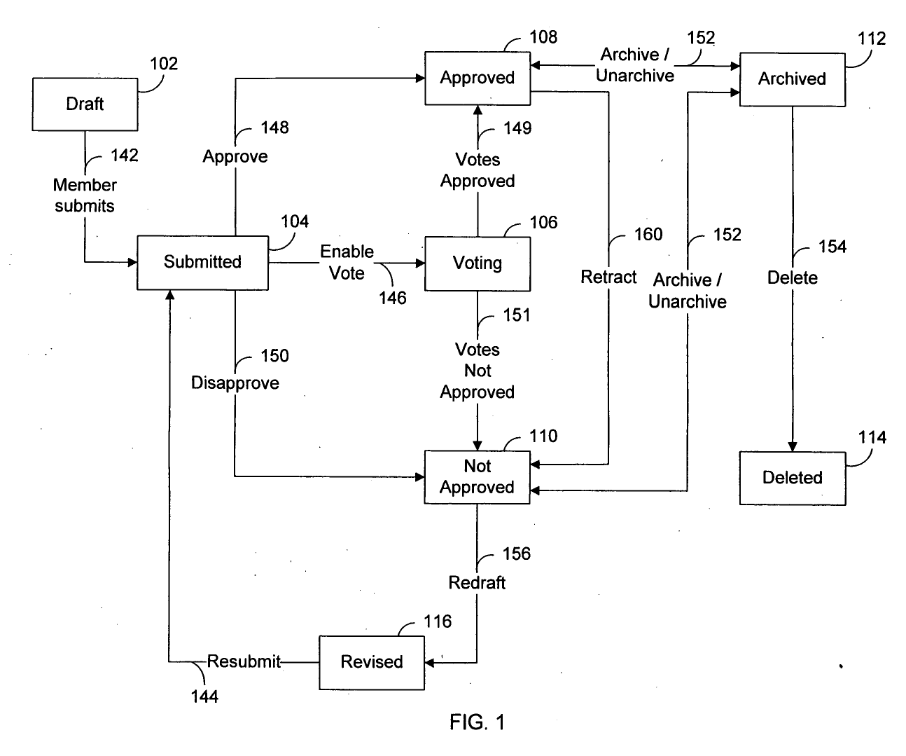

The cooperative work and decision making in the system is organized around a workflow for documents and decisions. This workflow specifies how documents are created, edited, maintained, and acted upon by the group. The system can be deployed with a default workflow (which will be described in reference to FIG. 1) that the inventors have found is effective for many types of organizations. This workflow provides a degree of customization through parameterization of certain of its aspects. Additionally, alternative workflows can be introduced into the system.

FIG. 1 illustrates the states of documents and the transitions of documents between states in a default workflow, in which all shared work products and decisions in a CoPE are represented by documents.

Any CoPE member can prepare a draft document in his/her personal workspace and then submit it for consideration (step 142), in which case the document in draft state 102 becomes a document in submitted state 104. Note that a document may but need not correspond to a file in the sense of a file system. A document may be stored in a portion of a file that holds other documents, in a single file dedicated to the document in question, or in multiple coordinated files. A document can be a word processing document, a markup language document, a PDF (portable document format) document, a spreadsheet document, a text document, a structured text document, or any other kind of document.

Submitted documents are open for comment and further discussion, within a time limit established by the coordinator. Depending on group rules, the coordinator either can act on the coordinator's own authority to approve (step 148), in which case the document is the approved state 128, or disapprove (step 150) the document, in which case the document is in the not approved state 130; or the coordinator can enable a vote on it (step 146), in which case the document is in the voting state 106. There are a number of voting modes that can have been selected for use by a group, and these are discussed below. Unless a document is approved within a time provided for voting in accordance with the voting mode, the document will be disapproved.

If the document is approved by vote (step 149), it is placed in the approved state 108; if the document is not approved by vote (step 151), it is placed in the not approved state 110. If a document is not approved (state 110), whether by vote or coordinator action, it can be redrafted (step 156) by the author or owner and placed in a revised state 116, which is private to the owner, like the draft state 102, and then be resubmitted by the author or owner to the group (step 144), which places the resubmitted document in the submit state 104. Optionally, the author or owner may be allowed to withdraw a document from consideration and discussion at other times in order to revise and resubmit it.

To keep the CoPE focused on current issues, the coordinator can choose to archive an document (approved or not approved) and its discussion, i.e., the comments related to the document (step 152). When a document is archived, it is no longer subject to discussion in the CoPE. The coordinator can also bring back an archived document and its discussion for active discussion (step 152). Material that is archived can be deleted (step 154), removing it permanently. Also, a document that was approved can be retracted by the coordinator (step 160) if circumstances change, placing the document in the not approved state 110. This could be the subject of a vote if the CoPE for the group is so configured.

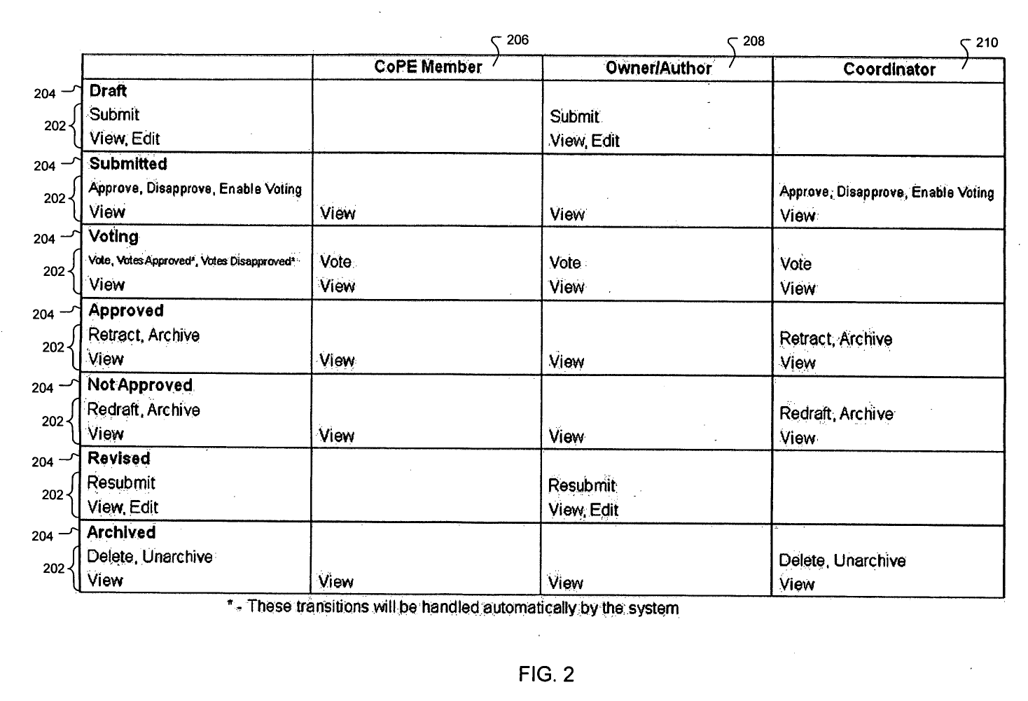

FIG. 2 is a table listing the modification privileges for various classes of users on documents in different stages of the approval workflow. These modification privileges are implicit in the options offered on a given document at a particular stage of the process to each user—member or coordinator—of the system. More particularly, the figure depicts the allowable actions 202 on a document, depending on the approval state 204 of the document and the privileges of individuals 206, 208, 210. The owner of a document is the only member who can submit a draft or resubmit his document. All members of a group can view, discuss and vote on documents. All of the other operations are reserved for the coordinator. The actions of the coordinator are kept in a viewable document so that all members can determine that group rules are being followed.

One additional optional aspect of the CoPE workflow is the workflow state where the document is world viewable. The world viewable state is one in which a document can be viewed by anyone, even anonymous users who are not members of the CoPE. Documents in this state can be viewed not only from the CoPE site but also on a separate public website that contains all world viewable documents from a particular CoPE. Transition to this state is managed in the same way the transition to the approved state is managed, with voter approval or direct coordinator action, according to the configuration of the CoPE.

User Interface

The system is accessible to users through a web interface, which presents a CoPE workspace to CoPE members.

The CoPE workspace is a context interactive work environment. It divides the web interface work area into sections for conducting work and for manipulating the context in which the work is being done.

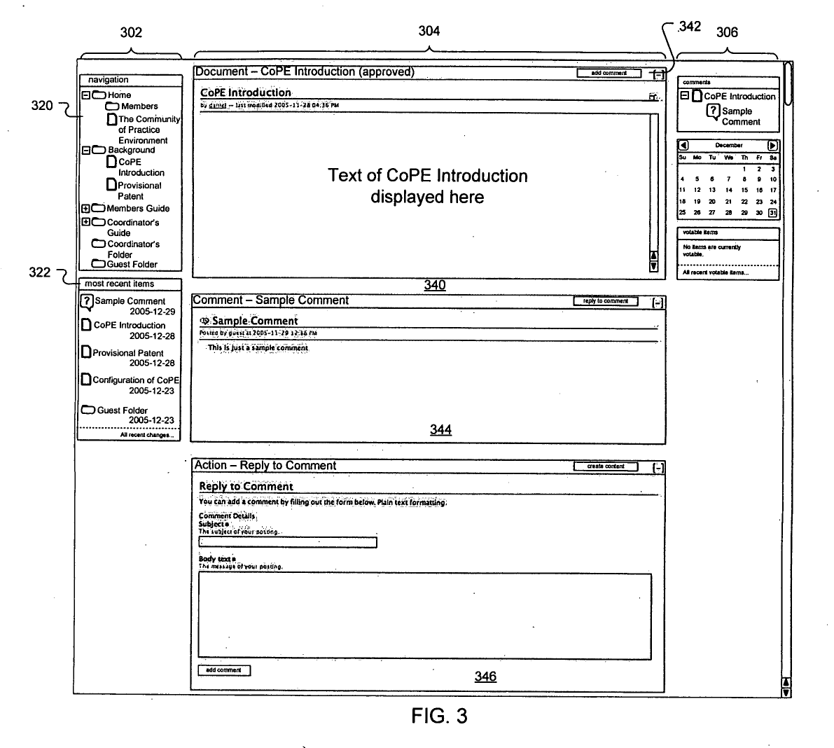

FIG. 3 shows an implementation of the member's user interface work area implemented in a three column format with a left column 302, a center column 304, and a right column 306.

The left column 302 of the work area displays a document navigation tree 320 that can be used to determine what document appears the document pane 340 of the center work area 304. This document is referred to as the focus document. The displayed document navigation tree shows the context for the focus document in a document folder hierarchy. There is also a small window 322 of recent items that facilitates keeping track of ongoing activity.

The center work area 304 includes three panes. Each pane is a workspace for accomplishing specific tasks applicable to the current focus document.

The focus document pane 340 displays the current focus document. As described above, the focus document is generally selected by a user navigating to a document in its context in the document navigation tree. The focus document can also be selected by following hyperlinks embedded into other documents or by using the search functionality.

This focus document pane 340 is the primary interface for viewing information and documents stored in the system.

A set of actions is available in the action bar 342 of the focus document pane 340 based on the context of the document being viewed, the state of the system, and the user's privileges. These actions can include creating content, editing content, submitting a document, and voting on a document or proposed action.

The comment pane 344 displays the current focus comment, if any. As will be described, the focus comment is determined by two contextual factors: 1) the focus document, and 2) the user's selection on the comment navigation tree.

The comment pane 344 is the primary interface for viewing (and removing, for coordinators) comments about the current focus document.

The action pane 346 is the primary input area for all system actions. When a member selects an action (requiring additional input) from anywhere in the interface (e.g., add a comment, submit document) this action pane will expand and be populated with information appropriate to the current focus document and a template for the requested action.

The right column 306 includes a display of a comment navigation tree 360 that a user can use to determine what comment or comments appear in the comment pane 344 of the center work area 304, and replies to those comments, in any. The comment that appears in the comment pane 344 is referred to as the focus comment. The comment navigation tree is only active if commenting is enabled on the focus document. If no comments have yet been added to a document, a message containing a suggestion to add the first comment will appear instead of the comment navigation tree. For documents that do not allow comments, a message to that effect will appear.

The group decision mechanisms of the system provide a structured way for groups to manage the state of documents moving through an approval process.

The group decision mechanisms control how documents move from one state in the workflow to another. Some of these transitions are automatic or simply involve a request on the part of a user. Others, such as approving a document, which for a particular group might constitute approval for publication, are more vital and require a group consensus of some sort. Group decision models or voting modes can include:
Threshold—fixed number of yes votes set by coordinator;
Plurality—over half of voters say yes; quorum of ½ of membership;
Majority—over half of members say yes;
Supermajority—over ⅔ of members say yes;
Consensus—over half of members say yes; less than ¼ say no; and
Unanimity—no negative votes; quorum of ½ of membership.

These models are examples of methods that can be selected for transitions using the customization function described below. Other models can be implemented as well.

As has been mentioned, in the system, an environment can be configured by its coordinator. In particular, the system implements a simple but parameterizable interface for members of a group. The system provides a configuration pages that allows the coordinator to customize various functions of the environment to the needs of his group, including the parameters of the member interface and the workflow.

The configuration page is a single self-explanatory web page that allows the coordinator of a group to set crucial parameters of the work process of the coordinator's group. The full range of modifiable parameters include whether or not votes are available to the group and whether majority, consensus, or some other form of voting is desired.

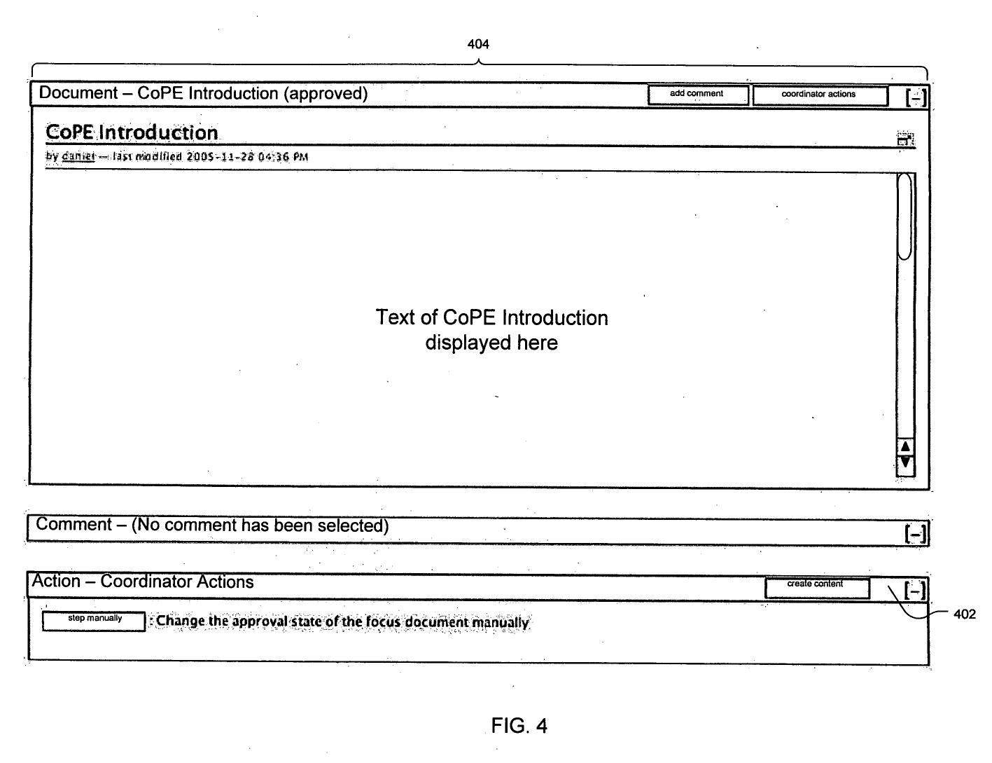

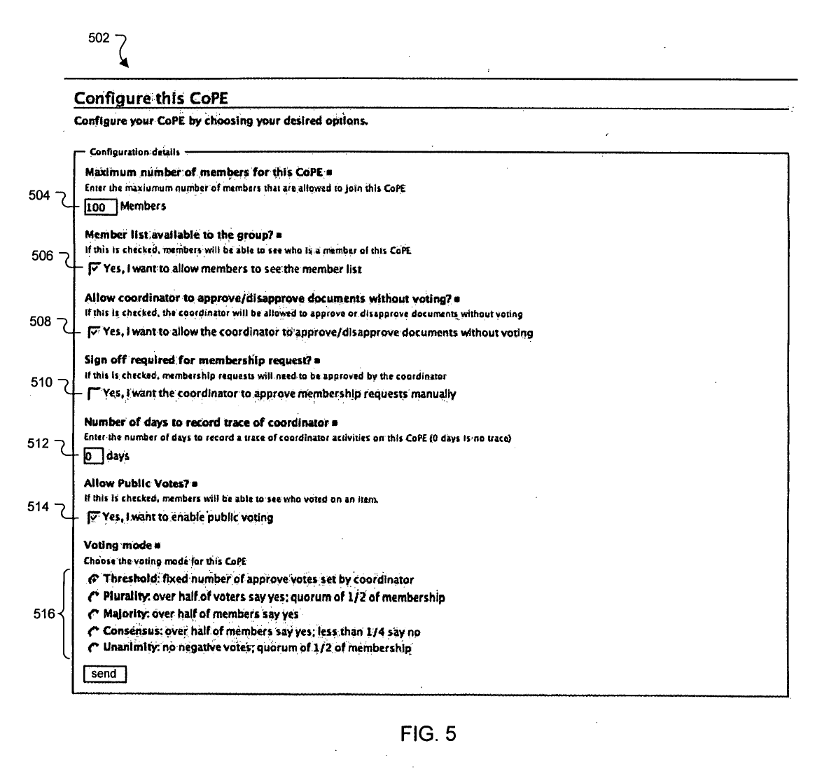

A CoPE system can be implemented with just three screens. Members will only see the members' screen described above in reference to FIG. 3. As illustrated in FIG. 4, the coordinator of each group will see a similar working screen with the additional coordinator functions visible in the center column 404 on a coordinator actions action bar 402. An example of the third screen will normally just be used once when a new CoPE is being established. This is described in reference to FIG. 5, below.

Member Actions

The following paragraphs describe how a user can interact with one implementation of a CoPE.

A user who is a member logs in with a name and a password. A user who is not a member and who wishes to join can click on the “join” or “new user” link and follow further instructions.

A member can create a new document or folder in the member's personal folder or in a shared folder. The member can click on the folder where he or she would like to create a new document or folder. A menu will appear in the document pane that allows the member to select what kind of item to be added—a document, a link, or a folder. After the selection is made from the menu, clicking on the “add new item” button will bring up a form that will ask for the appropriate information for the type of item.

When adding a document, it is possible to upload an existing file as the document. In one implementation, this file must be a PDF file, a Microsoft® Word file, or a text file.

The first step of viewing a document is to find the document within the navigation tree. The navigation tree is organized by folders and uses the convention of a + sign to indicate a folder has items in it and can be expanded.

Another way to find a document is by searching for it by keyword or keywords in the search box.

When the document has been found, clicking on the document will cause it to become the focus document and be displayed in the document pane of the member workspace. The document pane will contain the title of the document, the approval state of the document in parenthesis, and any action buttons that the member has permissions for.

Comments for the focus document are located on the right side of the screen in the comments box. The comments box lists the subjects of all the comments for the focus document. Clicking on the subject of the comment will display the comment body in the comment pane underneath the document. Initially, in the comments box, only the top level comments are displayed, i.e., replies to comments are not displayed. If a comment has replies, clicking on the + sign will expand the replies to that comment.

To add a comment to the focus document document, the member clicks on an add comment button. This will cause an add comment form to be displayed in an actions pane.

To reply to a comment, the member chooses the comment to reply to from the comments box. It will appear in the comment pane and there will be a reply to comment button. Clicking on this button will bring up a reply to comment form will appear in the action pane.

When a member first creates a document, it will be in draft state. A document in draft state is not viewable by others. A document in draft state will have a submit action button. Clicking on this button changes the state of the document to submitted. A document in submitted state is viewable by all members of the group.

Documents to be voted on can be found in the votable items box on the workspace. Clicking on a document there will cause it to appear in the document pane. A vote action button will be available if the member is eligible to vote. Clicking on the vote action button will cause a ballot to appear in the action pane. The member fills out the ballot and clicks on the submit button to vote.

Documents in a member's personal folder can be moved, deleted, copied, and edited by the member.

Documents in a shared folder can be edited or deleted by a member only if the member is the owner of the document and the document is in draft state.

Coordinator Actions

The following paragraphs describe how a user who is the coordinator can interact with one implementation of a CoPE.

Optionally, it can be the coordinator's responsibility to approve membership. In this case, new users who request to join the CoPE will not have access to the CoPE until the coordinator approves their membership request. If there are membership requests to approve, they will appear in the right column of the coordinator's user interface workspace, in a box called ‘membership requests’. A drop down menu is available where the coordinator can select to approve the membership request or reject the request and send an appropriate message.

The coordinator can add folders to and delete folders from the navigation tree. The coordinator can also change the name, description, and privacy mode of a folder. A folder can have one of four privacy modes: private, public, shared, and world. When a folder is in the private mode, it is only visible to its owner. Only the owner can add content to it and edit its properties (e.g., name of folder, privacy mode of folder). When a folder is in public mode, it is visible to all members of the group. However, only the coordinator can add content and edit its properties. When a folder is in shared mode, it is visible to all members of the group. Also, any member of the group can add content to it. Only the coordinator can edit the properties of the folder. When a folder is in world mode, it is visible to everyone, including people who are not members of the CoPE. Only the coordinator can edit the properties of the folder and add content to it.

The coordinator can clean up the site by archiving documents and by deleting documents that are not needed any longer. A document must be in the approved state or not approved state before it can be archived.

The coordinator has the ability to change the state of any documents in the CoPE that have been submitted, subject to configuration, for example, configuration as to whether the coordinator can approve or disapprove a document, or retract a document after approval, without a vote.

When a document is in the submitted state, the coordinator can call a vote on it. This allows members of the CoPE to vote on whether they approve or disapprove of the document. If enough approve votes are collected before the voting deadline according to the voting mode, the document automatically gets approved and its state changes to the approved state.

The coordinator can call a vote on a document by making it the focus document and clicking on a call vote action button in the action pane. The coordinator clicks on this button and fills out the form. The form requires several inputs including the day voting ends for the document and, for some voting methods, how many votes are required for the item to be approved. When the form is submitted, the state of the document will be changed to the voting state.

The coordinator can add a subgroup to the CoPE. To add a subgroup, the coordinator brings up a user interface form and enters information about the subgroup. Each subgroup has its own folder, as the group does, which is where access privileges are maintained. Members of a subgroup can submit documents to the subgroup and vote on them as a subgroup.

The coordinator can add members to a subgroup from a list of all members of the CoPE.

The coordinator can make ongoing changes to the configuration of the CoPE. In one implementation, configuration changes can be specified at any time, and will be carried out immediately.

As illustrated in FIG. 5, the coordinator in one implementation uses a configuration form 502, which initially has the current configuration choices filled in. The coordinator can make any desired changes and then click a submit button. The general parameter choices include:

1) Maximum number of members 504;

2) Member list available to the group or not 506;

3) Coordinator can approve or disapprove documents without a vote 508;

4) No signoff on membership request; all join requests are honored 510; and

5) The number of days to retain trace of coordinator actions that is viewable by all 512.

Some important configuration options involve voting.

6) Individual votes made available to the group or subgroup or not 514. This determines whether individual voting is visible by all members of the group or subgroup.

7) Voting method choices 516: There are five voting modes, in increasing order of stringency:

a) Threshold—fixed number of yes votes set by coordinator;

b) Plurality—over half of voters say yes; quorum of ½ of membership;

c) Majority—over half of members say yes;

d) Consensus—over half of members say yes; less than ¼ say no; and

e) Unanimity—no negative votes; quorum of ½ of membership.

Embodiments of the invention and all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer-readable medium, e.g., a machine-readable storage device, a machine-readable storage medium, a memory device, or a machine-readable propagated signal, for execution by, or to control the operation of, data processing apparatus. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them,. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Particular embodiments of the invention have been described. Other embodiments are within the scope of the following claims. For example, the steps recited in the claims can be performed in a different order and still achieve desirable results.

What is claimed is:

1. A computer-implemented method for computer supported cooperative work, comprising:
establishing an environment to support a group, where the group has a coordinator, and the group has one or more members;
managing documents according to a respective document state for each document in the environment, the possible document states including at least a submitted state, a voting state, an approved state, and a not approved state, where the first member submitting the document to the group places the document in the submitted state, the coordinator enabling voting on the document moves the document from the submitted to the voting state, the members approving the document moves the document from the voting to the approved state, and the members disapproving the document moves the document from the voting to the not approved state;
receiving from a first member of the group a first document submitted to the group;
receiving from the coordinator an input enabling voting on the first document by members of the group and moving the first document from the submitted state to the voting state; and
receiving voting input from the members approving the first document while the first document is in the voting state and in response moving the first document to the approved state.

2. The method of claim 1, further comprising:
receiving from a second member of the group a second document submitted to the group;
receiving from the coordinator an input enabling voting on the second document by members of the group and moving the second document from the submitted state to the voting state; and
receiving voting input from the members not approving the second document while the second document is in the voting state and in response moving the second document to the not approved state.

3. The method of claim 1, further comprising:
receiving from the coordinator an input moving a third document directly from the submitted state to the approved state or to the not approved state.

4. The method of claim 1, further comprising:
receiving from the coordinator an input retracting a fourth document from the approved state and moving the fourth document to the not approved state without voting approval.

5. The method of claim 1, further comprising:
receiving from the coordinator an input retracting a fourth document from the approved state and moving the fourth document to the not approved state without voting approval from the members of the group.

6. The method of claim 1, further comprising:
receiving, displaying, and managing comments from members concerning documents and other comments in a hierarchical, context-based way.

7. The method of claim 1, further comprising:
presenting to members a user interface allowing the members to request from the environment one or more actions, including at least one of the actions of:
submitting content;
organizing documents;
searching for document;
commenting on documents;
commenting on comments on documents; and
voting on documents.

8. The method of claim 1, further comprising:
presenting to the coordinator a user interface allowing the coordinator to request from the environment one or more actions, including at least one of the actions of:
accepting members into the group;
establishing document access and modification privileges for members of the group;
sending documents to and recovering documents from archival storage; and
retracting documents from an approved state.

9. The method of claim 1, wherein the members and coordinator interact with the environment over a web based user interface.

10. A computer-implemented method, comprising:
establishing a cooperative environment for a group of members, the environment being implemented by computer programs, the environment being for members to use in managing and cooperatively working on documents, where the group has a coordinator, and the group has one or more members, and where the environment implements document management including assigning documents in the environment to one of multiple possible states, the possible states including a submitted state, a voting state, an approved state, and a not approved state;
receiving from a coordinator of the group configuration information establishing configuration parameters, including configuration parameters controlling:
whether or not voting by members is required to move a document from the voting state to the approved state; and
selection of a group decision model.

11. The method of claim 10, wherein the configuration parameters further include configuration parameters controlling:
whether or not individual votes are visible to all members of the group;
whether or not all requests to join the group are honored; and
how long a trace of coordinator actions is kept for viewing by all members of the group.

12. The method of claim 10, wherein the documents represent elements of a business process.

13. The method of claim 10, wherein the possible states further include an archived state and a deleted state.

14. A computer program product, tangibly embodied on a computer-readable medium, the product comprising instructions operable to cause data processing apparatus to:
receive input from a coordinator defining a group and in response establish an environment for the group, the group comprising one or more members;
accept new members into the group;
assign document access and modification privileges to members of the group;
manage documents for group, each document being in a respective one of a number of possible states, the possible states including a submitted state, a voting state, an approved state, and a not approved state;
manage comments made by members concerning documents;
configure group decision making parameters in response to input from the coordinator of the group; and
implement a workflow for documents controlling movement of documents among the possible states under group decision making in accordance with the group decision making parameters.

15. The product of claim 14, wherein:
the group decision making parameters include selection of a voting mode, the selectable voting modes including plurality and majority.

16. The product of claim 14, further comprising instructions operable to cause data processing apparatus to:
define multiple environments each for a respective group having a respective coordinator; and
define within a single group one or more subgroups.
